(19) United States
(12) Patent Application Publication
(10) Pub. No.: US 2004/0125762 A1
(43) Pub. Date: Jul. 1, 2004

(54) Device, system, method and computer readable medium for attaching to a device identifited by an access point name in a wide area network providing particular services

(76) Inventors: Amit Haller, Belmont, CA (US); Peter Fornell, Lake Oswego, OR (US); Avraham Itzchak, Ra'anana (IL); Ziv Haparnas, Tel Aviv (IL); Yosi Levi, Kefar Aviv (IL); Eduard Kvetny, Rishon Letzion (IL); Amir Glick, Tel Aviv (IL); Vladimir Holostov, Kfar Saba (IL)

Correspondence Address: VIERRA MAGEN MARCUS HARMON & DENIRO LLP, 685 MARKET STREET, SUITE 540, SAN FRANCISCO, CA, 94105, US

(21) Appl. No.: 10/666,776

(22) Filed: Sep. 18, 2003

Related U.S. Application Data
(63) Continuation-in-part of application No. 10/619,857, filed on Jul. 14, 2003.
Application No. 10/619,857 is a continuation-in-part of application No. 10/435,098, filed on May 9, 2003.
Application No. 10/435,098 is a continuation-in-part of application No. 09/932,180, filed on Aug. 17, 2001.

(51) Int. Cl. H04Q 7/00

(52) U.S. Cl. 370/313

(57) ABSTRACT

A device, method, system and computer readable medium allows for simultaneously attaching multiple APNs in a WAN, having a cellular network, to a short distance wireless network. In an embodiment of the present invention, a device, such as a cellular telephone, includes a processor and memory to store a software component for simultaneously attaching to multiple APNs providing services to a short distance wireless network responsive to a terminal in the short distance wireless network communicating with the device. In an embodiment of the present invention, the communicating includes receiving a short-range radio message including a destination address, such as an IP address and port number, identifying the selected APN.

### RELATED APPLICATION

This application is a continuation-in-part of U.S. patent application Ser. No. 10/619,857, entitled “A Device, System, Method And Computer Readable Medium Selectively Attaching To A Cellular Data Service”, filed on Jul. 14, 2003, which application is a continuation-in-part of U.S. patent application Ser. No. 10/435,098, entitled “Device, System, Method And Computer Readable Medium For Fast Recovery of IP Address Change”, filed on May 9, 2003, which application is a continuation-in-part of Ser. No. 09/932,180, entitled “A System, Device and Computer Readable Medium for Providing Network Services on a Mobile Device,” filed on Aug. 17, 2001, which applications are incorporated herein by reference.

### FIELD OF THE INVENTION

This invention relates generally to networks.

### BACKGROUND OF THE INVENTION

Wide Area Networks (“WAN”) typically includes multiple addresses for obtaining a service for a device in the WAN. A cellular network, such as a Global System for Mobile Communications (“GSM”) network or Universal Mobile Telecommunications System (“third-generation (3G)”) network, may be included in the WAN and provides services to cellular devices, such as cellular telephones. For example, a cellular telephone may need access to a cellular data service and a GSM network provides a General Packet Radio Service (“GPRS”) at a particular address, or in particular at an IP domain having predetermined privileges. In a GSM network this particular address in known as an Access Point Name (“APN”).

A WAN typically provides multiple APNs. For example, a first APN may be provided for a GPRS service, a second APN may be provided for Wireless Access Protocol (“WAP”) service, a third APN may be provided to a Hypertext Translation Protocol (“HTTP”) service, a fifth APN may be provided for a messaging service and still a sixth APN may be provided for Internet access.

However, many cellular networks do not allow a cellular device to attach to multiple APNs simultaneously.

Moreover, a cellular device may also be included in a short distance wireless network that includes a plurality of terminals. These terminals may need simultaneous access to multiple APNs. For example, one terminal, such as a messaging terminal, may need access to a messaging server; while a second terminal, such as a laptop computer may need access to the Internet. Thus, even if a cellular network allows for a cellular device to attach to multiple APNs simultaneously, typical cellular devices do not allow for the transfer of data between terminals in a short distance wireless network to multiple APNs.

Therefore, it is desirable to provide a device, system, method and computer readable medium that allows for simultaneously attaching to multiple APNs and transferring data between terminals in a short distance wireless network and the multiple APNs.

### SUMMARY

A device, method, system and computer readable medium allows for simultaneously attaching multiple APNs in a WAN, having a cellular network, to a short distance wireless network. In an embodiment of the present invention, a device, such as a cellular telephone, includes a processor and memory to store a software component for simultaneously attaching to multiple APNs providing services to a short distance wireless network responsive to a terminal in the short distance wireless network communicating with the device. In an embodiment of the present invention, the communicating includes receiving a short-range radio message including a destination address, such as an IP address and port number, identifying the selected APN.

In an embodiment of the present invention, a wireless handheld device, such as a cellular telephone, includes a processor and memory to store a software component for simultaneously attaching a short distance wireless network to a wide area network having a first address providing a first service and a second address providing a second service.

In an embodiment of the present invention, the first and second addresses identify a domain providing respective predetermined privileges.

In an embodiment of the present invention, the first and second addresses are access point names (“APNs”).

In an embodiment of the present invention, the first and second addresses include a first and second port number.

In an embodiment of the present invention, the first service provides a wireless application protocol (“WAP”), access to the Internet, a hypertext transfer (“HTTP”) protocol or a multimedia messaging service center (“MMSC”) service.

In an embodiment of the present invention, the communicating includes receiving a short-range radio message including an IP address and port number.

In an embodiment of the present invention, the wide area network is a Global System for Mobile communications (“GSM”) cellular network and the short distance wireless network is a Bluetooth™ wireless local area network.

In an embodiment of the present invention, the software component further includes a table of available APNs.

In an embodiment of the present invention, a method for communicating with a cellular network is provided. A first terminal in a short distance wireless network generates a first short-range radio message including a first IP address and a first port number for the cellular network. A device receives the first short-range radio message and determines whether the device is attached to the first IP address and first port number. A cellular signal is generated by the device, requesting a first service from the cellular network, responsive to the first short-range radio message. A second terminal in a short distance wireless network generates a second short-range radio message including a second IP address and a second port number for the cellular network. The device receives the second short-range radio message and determines whether the device is attached to the second IP address and second port number. A cellular signal is generated by the device, requesting a second service from the cellular network, responsive to the second short-range radio message. Data is transferred between the first IP address and port number and the second IP address and port number, and the device.

A system for providing communication between a cellular network and a short distance wireless network includes a handheld wireless device and a first wireless device. The hand-held wireless device includes a cellular transceiver to communicate with the cellular network and a short-range transceiver to communicate with the short-range radio network The short-range transceiver receives a first short-range radio message including a first APN and a second short-range radio message including a second APN. The hand-held device includes a memory, coupled to the cellular and short-range radio transceivers, to store a software component to simultaneously transfer a plurality of packets to the first APN and the second APN responsive to the first and second short-range radio messages. The first wireless device generates the first and second short-range radio messages.

An article of manufacture, including a computer readable medium, comprises a short-range radio software component that provides a short-range radio signal in a short distance wireless network. A cellular software component provides a communication signal in a cellular network. A software component to simultaneously transfers a plurality of packets between the a first APN and a second APN in the cellular network and the short distance wireless network responsive to a first short-range radio message including a first IP address and a first port number and a second short-range radio message including a second IP address and a second port number.

Other aspects and advantages of the present invention can be seen upon review of the figures, the detailed description, and the claims that follow.

### BRIEF DESCRIPTION OF THE FIGURES

FIG. 1 illustrates a system according to an embodiment of the present invention.

FIG. 2 illustrates thin terminals and a wireless device according to an embodiment of the present invention.

FIGS. 3a-b are hardware block diagrams of a wireless device and a wireless hand-held device according to an embodiment of the present invention.

FIGS. 4-7 are software block diagrams for a wireless device according to an embodiment of the present invention.

FIG. 8 is a software block diagram of manager software in manager server 102 illustrated in FIG. 1 according to an embodiment of the present invention.

FIGS. 9a-9b are flowcharts of methods according to embodiments of the present invention.

### DETAILED DESCRIPTION

I. System Overview

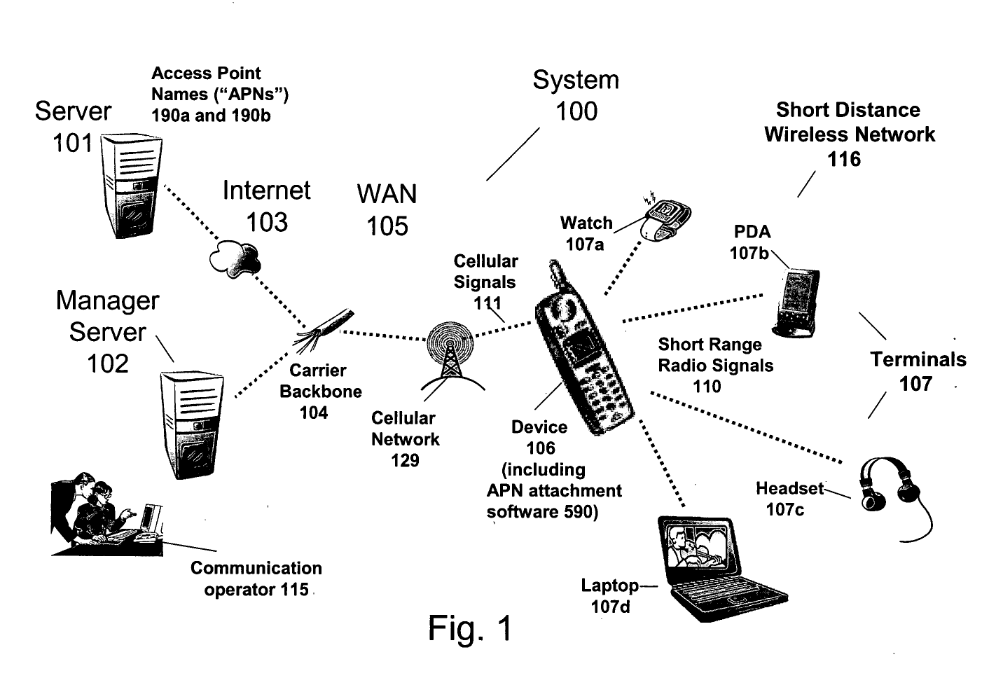

The following description and claims relate to a device, method, system, and computer readable medium for simultaneously attaching a short distance wireless to a plurality of IP domains have respective predetermined privileges in a WAN. In an embodiment of the present invention, an Internet Protocol (“IP domain”) having predetermined privileges is an APN in a GSM cellular network. In an embodiment of the present invention, a device 106 includes APN attachment software component 590 that simultaneously attaches terminals 107 in short distance wireless network 116 to WAN 105, and in particular to a plurality of APNs 190a and 190b, shown in FIG. 1. APN attachment software component 590 allows for the simultaneous transfer of data between terminals in short distance wireless network 116 and components in WAN 105, such as server 101, in response to a short-range radio messages, from terminals, including a destination address, such as an IP address and port number, identifying the selected APNs.

In an embodiment of the present invention, an IP domain having predetermined privileges includes, for example, a GPRS service, a WAP service, a HTTP service, a messaging service or an Internet access service.

In an embodiment of the present invention, APN attachment software component 590 establishes a plurality of simultaneous attachments or connections between terminals in short distance wireless network and multiple APNs. In other words, APN attachment software component 590 initiates and maintains a session between device 106 and a processing device executing service software that provides a service or data identified by an address or APN in a WAN. Device 106, including APN attachment software 590, is able to maintain multiple simultaneous sessions with a plurality of APNs by routing data between the various APNs and the requesting terminals in short distance wireless network 116. In an embodiment of the present invention, multiple APNs may identify multiple services located on a single or multiple processing devices or servers. Simultaneous attachments include transferring data that may be briefly buffered or queued while waiting for execution of software or transmission.

In an embodiment of the present invention, a short distance wireless network is a network of processing devices, such as a personal computer or headset, that span a relatively small physical area, wherein at least one device generates and receives a short-range radio signal for communicating with another device in the network. In an embodiment of the present invention, a short-range radio signal can travel between approximately 0 and approximately 1000 feet. An example of a short distance wireless network includes a network of devices formed by Bluetooth™, HomeRF, 802.11 technologies, or an equivalent, singly or in combination. In an embodiment of the present invention, each processing device in a short distance wireless network has its own processing unit that executes a software component stored on the processing device memory, but also may access data and devices on the short distance wireless network. In an embodiment of the present invention, a wire, and in particular an Ethernet, provides communication between two or more processing devices in a short distance wireless network. In an alternate embodiment, electromagnetic signals provide wireless communication between one or more processing devices in a short distance wireless network. In still another embodiment, both wires and electromagnetic signals provide communication between processing devices in a short distance wireless network.

In an embodiment of the present invention, a WAN includes multiple local area networks (“LANs”) and/or short distance wireless networks connected over a relatively large distance. Telephone lines and electromagnetic signals, singly or in combination, couple the LANs and/or short distance wireless networks in a WAN. In an embodiment of the present invention, WAN 105 includes a cellular network 129 generating and receiving cellular signals 111. In an embodiment of the present invention, cellular network 129 includes multiple APNs 190a and 190b identifying respective IP domains or services provided by a singly or multiple processing devices in WAN 105. In an embodiment of the present invention, a cellular network is defined as a communication system dividing a geographic region into sections, called cells. In an analog embodiment of the present invention, the purpose of this division is to make the most use out of a limited number of transmission frequencies. In an analog embodiment of the present invention, each connection, or for example conversation, requires its own dedicated frequency, and the total number of available frequencies is about 1,000. To support more than 1,000 simultaneous conversations, cellular systems allocate a set number of frequencies for each cell. Two cells can use the same frequency for different conversations so long as the cells are not adjacent to each other.

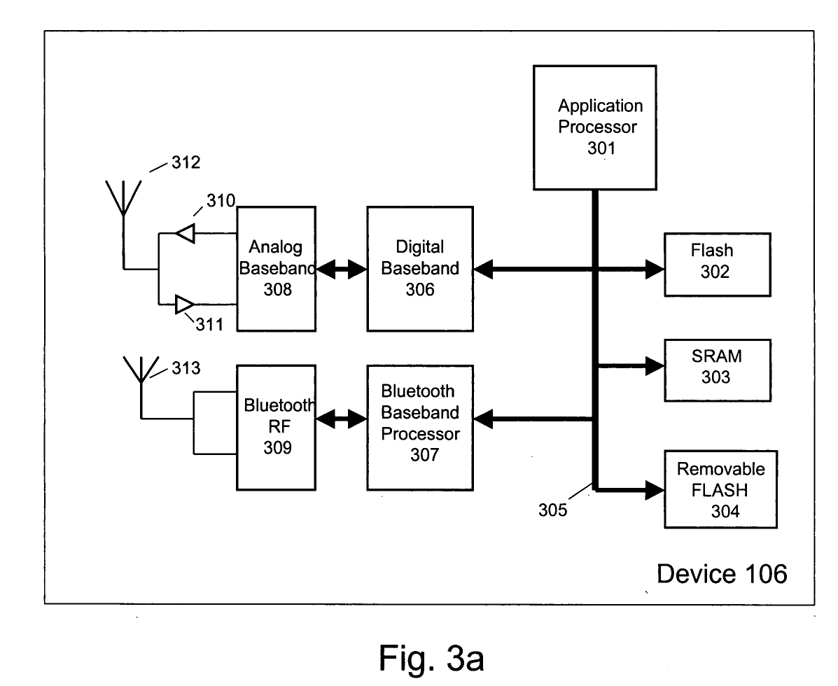

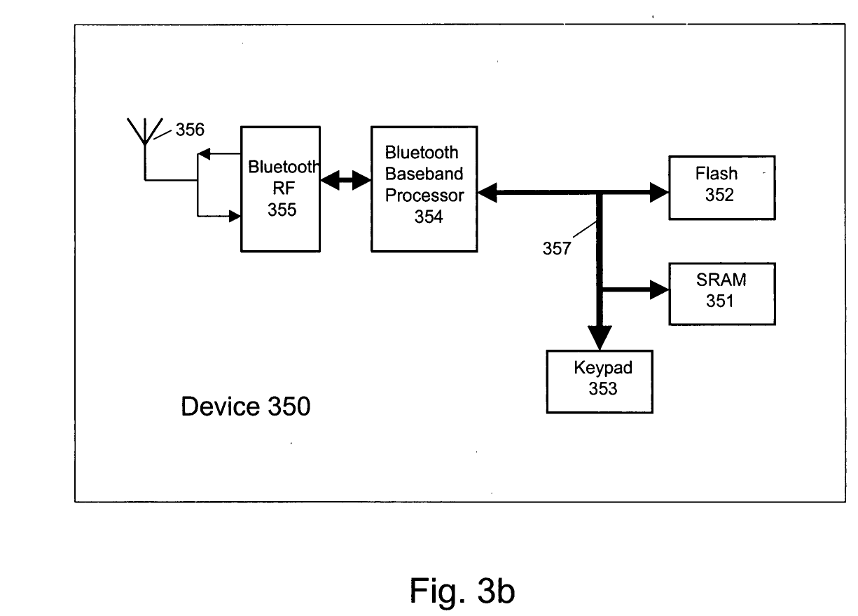

FIG. 1 illustrates system 100 according to an embodiment of the present invention. System 100 includes other devices or terminals 107 coupled to wireless device 106. In an embodiment of the present invention, device 106 and one or more terminals 107 communicate to form a short distance wireless network 116. In an embodiment of the present invention, terminals 107 are coupled to device 106 by short-range radio signals 110 to form short distance wireless network 116. In an embodiment of the present invention, some or all of terminals 107 may have wired connections. In an embodiment of the present invention, terminals 107 include a watch 107a, PDA 107b, headset 107c and laptop computer 107d that generate respective output signals. In an alternate embodiment, fewer or more terminals are used in short distance wireless network 116. In an alternate embodiment, terminals 107 include a desktop computer, a pager, a pen, a printer, a watch, a thin terminal, a messaging terminal, a digital camera or an equivalent. In an embodiment of the present invention, terminals 107 include a Bluetooth™ 2.4 GHz transceiver. Likewise, device 106 includes a Bluetooth™ 2.4 GHZ transceiver. In an alternate embodiment of the present invention, a Bluetooth™ 5.7 GHZ transceiver is used. Hardware for device 106 and terminals 107 are illustrated in FIGS. 3a-b in an embodiment of the present invention.

In alternate embodiments of the present invention, other local wireless technologies, such as 802.11 or HomeRF signals, are used to communicate between device 106 and terminals 107.

In an embodiment of the present invention, WAN 105 is coupled to device 106. In an embodiment of the present invention, WAN 105 includes a cellular network 129 transmitting and receiving cellular signals 111. In an embodiment of the present invention, cellular signals 111 are transmitted using a protocol, such as a GSM protocol with a GPRS. In alternate embodiments, a Code Division Multiple Access (“CDMA”), CDMA 2000, Universal Mobile Telecommunications System (“UMTS”), Time Division Multiple Access (“TDMA”), or 3G protocols or an equivalent is used.

In an embodiment of the present invention, WAN 105 includes carrier backbone 104, servers 101-102 and Internet 103. In an embodiment of the present invention, IP packets are transferred between the components illustrated in FIG. 1. In alternate embodiments of the present invention, other packet types are transferred between the components illustrated in FIG. 1. In an embodiment of the present invention, a packet includes predetermined fields of information, such as header field and data field. A header field may include information necessary in transferring the packet, such as a source IP address. In an embodiment of the present invention, short-range radio signals 110 from a terminal in short distance wireless network 116 include an IP address and port number identifying a requested service at a particular APN.

In an embodiment of the present invention, WAN 105 includes an IP public or private network, such as a corporate secured network using a Virtual Private Network (“VPN”).

In an alternate embodiment of the present invention, device 106 is coupled to WAN 105 by an Ethernet, Digital Subscriber Line (“DSL”), or cable modem connection, singly or in combination.

In an embodiment of the present invention, device 106 is a cellular handset or telephone. In an alternate embodiment of the present invention, device 106 is a cellular enabled PDA, wireless modem and/or wireless laptop computer.

In an embodiment of the present invention, WAN 105 is coupled to a wireless carrier internal network or carrier backbone 104. In an embodiment of the present invention, server 102 is coupled to carrier backbone 104. In an alternate embodiment of the present invention, carrier backbone 104 is coupled to Internet 103. Server 101 is coupled to Internet 103. In an embodiment of the present invention, servers 101 and 102 provide information, such as web pages or application software components, to terminals 107 by way of device 106. In an embodiment of the present invention, manager server 102 provides a microrouter 404 and/or network service plug-ins 406a-k to device 106, as described below. Further, manager server 102, monitors applications and terminals in a short distance wireless network 116. In an embodiment of the present invention, terminals 107 share services and communicate by way of device 106.

In an embodiment of the present invention, one or more terminals in short distance wireless network 116 accesses information and/or services from server 101. In an embodiment of the present invention, server 101 executes first and second service software identified by APN 190a and APN 190b. In an embodiment of the present invention, server 101 provides device 106 with a public IP address to allow for devices in short distance wireless network 116 to communicate, by way of a TCP/IP protocol connection, with server 101. In an alternate embodiment, server 101 is a termination point for a session initiated by device 106 (or terminals 107) and an alternate address server provides public IP address to device 106.

II. Hand-Held Device/Terminal Hardware

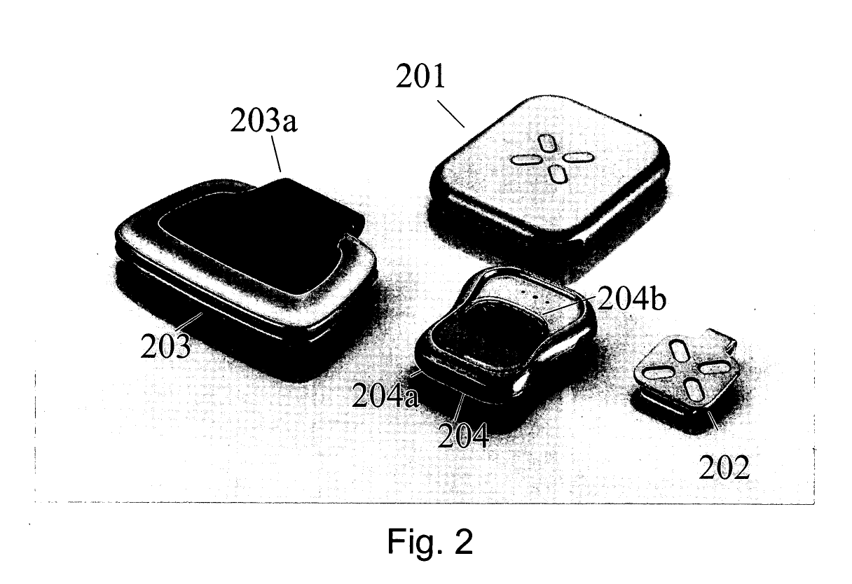

FIG. 2 illustrates embodiments of terminals 107 and device 106. In an embodiment of the present invention, there are two types of terminals: 1) smart terminals and 2) thin terminals. In an alternate embodiment of the present invention, smart terminals execute user logic and applications. Smart terminals have a relatively powerful processing unit, operating system and applications. Their main needs from a short distance wireless network 116 are access to a WAN 105 through TCP/IP and other network services such as storage and execution. For example, a laptop computer 107d and PDA 107b are smart terminals. Thin terminals have a relatively low power processing unit and operating system. They are mainly used as peripherals to an application server in a short distance wireless network 116 and their main task is user interaction, rendering output for a user and providing an application server with a user's input. For example, a watch 107a or messaging terminals can be thin terminals.

FIG. 2 illustrates thin terminals. Voice terminal 204 includes a display 204b and a retractable keypad 204a. Messaging Terminal 203 is illustrated in a closed position with a hinge 203a used to open and close terminal 203. Terminal 203 also includes a miniature QWERTY keyboard and display when opened.

In an embodiment of the present invention, device 201 is a cellular modem and includes a clip 202 for a belt.

FIG. 3a illustrates a hardware block diagram of device 106 in an embodiment of the present invention. Device 106 includes both internal and removable memory. In particular, device 106 includes internal FLASH (or Electrically Erasable Programmable Read-Only Memory (“EEPROM”) and Static Random Access Memory (“SRAM”) 302 and 303, respectively. Removable FLASH memory 304 is also used in an embodiment of the present invention. Memories 302, 303, and 304 are coupled to bus 305. In an embodiment of the present invention, bus 305 is an address and data bus. Application processor 301 is likewise coupled to bus 305. In an embodiment of the present invention, processor 301 is a 32-bit processor.

Bluetooth™ processor 307 is also coupled to bus 305. Bluetooth™ RF circuit 309 is coupled to Bluetooth™ processor 307 and antenna 313. Processor 307, RF circuit 309 and antenna 313 transmit and receive short-range radio signals to and from terminals 107, illustrated in FIG. 1, or device 350, illustrated in FIG. 3b.

Cellular, such as GSM, signals are transmitted and received using digital circuit 306, analog circuit 308, transmitter 310, receiver 311 and antenna 312. Digital circuit 306 is coupled to bus 305. In alternate embodiments, device 106 includes a display, a speaker, a microphone, a keypad and a touchscreen, singly or in combination.

In a preferred embodiment of the present invention, device 106 has a dual bus architecture where a first processor is coupled to a cellular transceiver by a first bus and a second processor is coupled to a short-range transceiver by a second bus. In an embodiment, a third bus couples the first and second processors.

FIG. 3b illustrates device 350 that is a hand-held device in an embodiment of the present invention. Device 350, in an embodiment of the present invention, is one of the terminals 107 illustrated in FIG. 1. Similar to device 106, device 350 includes SRAM and FLASH memory 351 and 352, respectively. Memories 351 and 352 are coupled to bus 357. In an embodiment of the present invention, bus 357 is an address and data bus. Keypad 353 is also coupled to bus 357. Short-range radio signals are transmitted and received using Bluetooth™ processor 354 and Bluetooth™ RF circuit 355. Antenna 356 is coupled to Bluetooth™ RF circuit 355. In an embodiment of the present invention, antenna 356 transmits and receives short-range radio signals. In alternate embodiments, device 350 includes a display, a speaker, a microphone, a keypad and a touchscreen, singly or in combination. As one of ordinary skill in the art would appreciate, other hardware components would be provided for device 350 in alternate embodiments of the present invention. For example in an embodiment in which device 350 is a laptop computer 107d, a disk drive and other input/output components are present.

In a preferred embodiment of the present invention, device 350 likewise has a dual bus architecture where a first processor is a first bus and a second processor is coupled to a short-range transceiver by a second bus. In an embodiment, a third bus couples the first and second processors.

III. Software

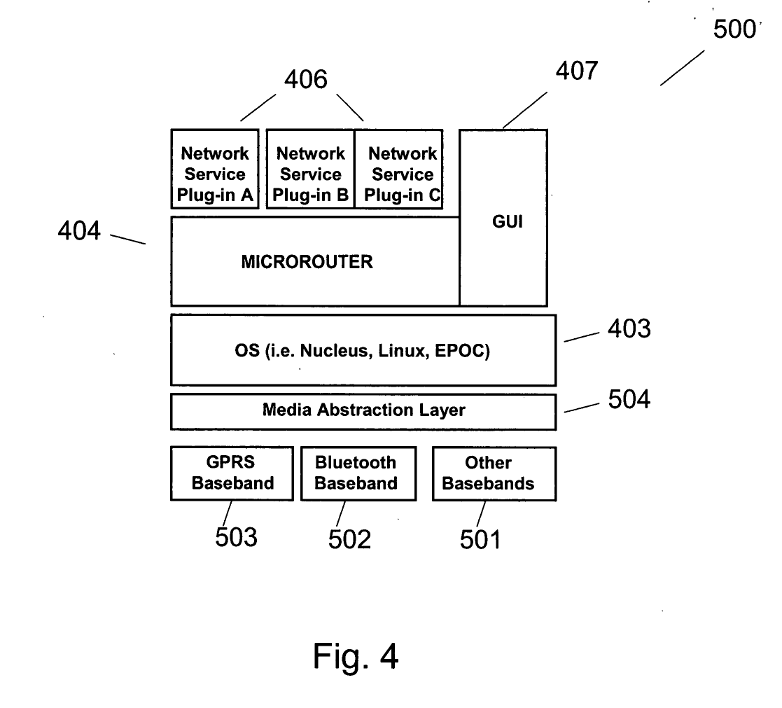

FIG. 4 illustrates a software architecture 500 for device 106 illustrated in FIG. 3a according to an embodiment of the present invention. In an embodiment of the present invention, software 500 is stored in FLASH memory 302. In an embodiment of the present invention, software components referenced in FIGS. 4-8 represent a software program, a software object, a software function, a software subroutine, a software method, a software instance, and a code fragment, singly or in combination. In an alternate embodiment, functions performed by software components illustrated in FIGS. 4-8 are carried out completely or partially by hardware.

In an embodiment of the present invention, software 500, or components of software 500, is stored in an article of manufacture, such as a computer readable medium. For example, software 500 is stored in a magnetic hard disk, an optical disk, a floppy disk, Compact Disk Read-Only Memory (“CD-ROM”), Random Access Memory (“RAM”), Read-Only Memory (“ROM”), or other readable or writeable data storage technologies, singly or in combination. In yet another embodiment, software 500, or components thereof, is downloaded from manager server 102 illustrated in FIG. 1.

Software 500 includes telecommunication software or physical layer protocol stacks, in particular cellular communication software 503 and short-range radio communication software 502. In an embodiment, communication software 503 is a GPRS baseband software component used with processor 306 to transmit and receive cellular signals including data packets. In an embodiment, communication software 502 is a Bluetooth™ baseband software component used with processor 307 to transmit and receive short-range radio signals. Other telecommunication software may be used as illustrated by other basebands 501.

In an embodiment of the present invention, operating system (“OS”) 403 is used to communicate with telecommunication software 502 and 503. In an embodiment of the present invention, operating system 403 is a Linux operating system, EPOC operating system available from Symbian software of London, United Kingdom or a PocketPC or a Stinger operating system available from Microsoft® Corporation of Redmond, Wash. or Nucleus operating system, available from Accelerated Technology, Inc. of Mobile, Ala. Operating system 403 manages hardware and enables execution space for device software components.

Media abstraction layer 504 allows operating system 403 to communicate with basebands 503, 502 and 501, respectively. Media abstraction layer 504 and other abstraction layers, described herein, translate a particular communication protocol, such as GPRS, into a standard command set used by a device and/or terminal. The purpose of an abstraction layer is to isolate the physical stacks from the rest of the device software components. This enables future usage of different physical stacks without changing any of the upper layer software and allows the device software to work with any communication protocol.

Furthermore, Graphics User Interface (“GUI”) 407 is provided to allow a user-friendly interface.

Microrouter 404 and network service plug-in 406 enables an IP based network or enhanced IP based network, respectfully.

A. Microrouter

Microrouter 404 enables an IP based network between device 106 and terminals 107. In an embodiment of the present invention, each terminal can leverage the existing IP protocol, exchange information with other terminals and gain access to a WAN through microrouter 404. Extended network services, such as network service plug-ins 406, may be added to microrouter 404. In an embodiment, manager server 102, installs microrouter 404 and network service plug-ins 406 on device 106.

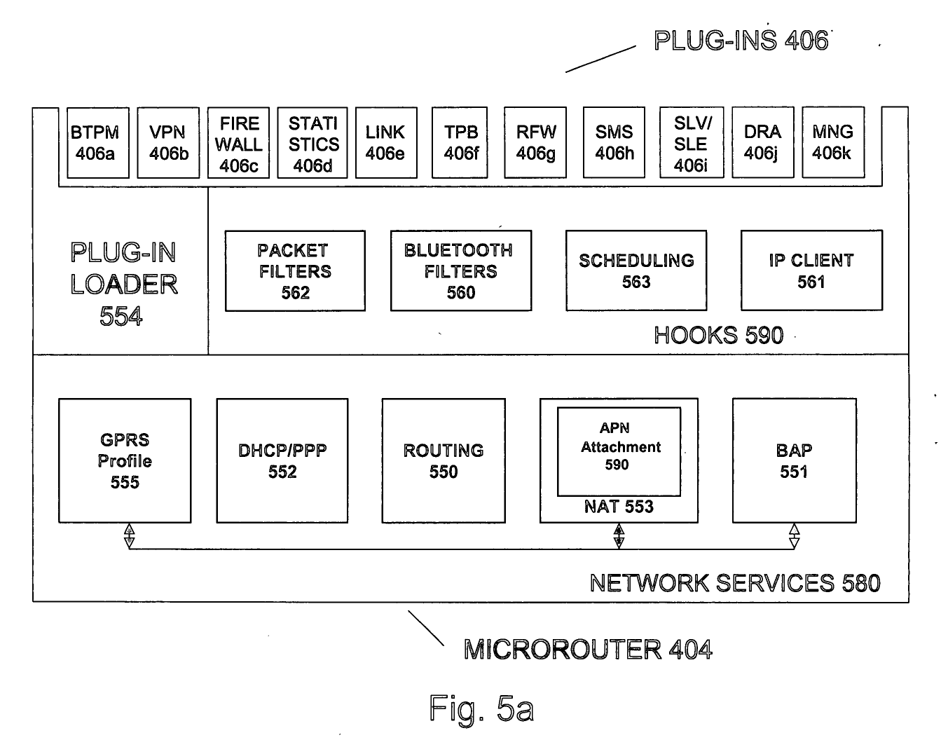

FIG. 5 illustrates software components of microrouter 404. In an embodiment of the present invention, routing software component 550, Bluetooth™ LAN Access Profile software component 551, Point-to-Point Protocol (“PPP”) software component 552 and Network Address Translator (“NAT”) software component 553 are included in microrouter 404. In an alternate embodiment, other software components, such as packet filters 562, Bluetooth™ filters 560, scheduling 563 and IP client 561 are included in microrouter 404. In still another embodiment, microrouter 404 includes hooks 590 for adding network services plug-ins 406.

1. Microrouter Services

In an embodiment, microrouter 404 services include software components for a short distance wireless network that has access to a WAN. In an embodiment, the software components included in a microrouter 404 are described below.

a. Bluetooth™ Access Profile (“BAP”)

BAP software component 551 enables Bluetooth™ terminals to gain access to short distance wireless network 116 and a WAN by using an IP protocol.

In an embodiment of the present invention, BAP 551 includes implementation of two Bluetooth™ usage profiles such as: 1) Bluetooth™ LAN Access Profile software and 2) Bluetooth™ Dial-Up Profile Software.

Bluetooth™ LAN Access Profile software component allows a LAN Access client in a terminal to obtain an private IP address and use the private IP address in order to gain connectivity to other short distance wireless network terminals or to a WAN, behaving as if they were on a short distance wireless network.

Bluetooth™ Dial-Up Profile software component enables a terminal to dial-up to any termination number and get IP services from that termination. In addition, a Bluetooth™ Dial-Up Profile (“DUP”) software component emulates termination in device 106. In an embodiment, microrouter 404 has either a Bluetooth™ LAN Access Profile software component or a Bluetooth™ Dial-Up Profile software component. In an alternate embodiment, microrouter 404 includes both Profile software components. In a Bluetooth™ Dial-Up Profile software component mode, a terminal dials a predefined number, for example 999, for which microrouter 404 will not actually dial the number over a cellular network, but emulates as if the number was dialed and a modem answered the call. Microrouter 404 will provide the terminal with an IP address and access to WAN 105. From the terminal's point of view it is as if the terminal dialed a number 999 to a modem and received an IP service from that modem, but in reality the terminal used DUP to obtain packet switching access to WAN 105 and the call was actually terminated at microrouter 404.

b. Routing

Routing software component 550 is responsible for transferring IP packets either in a short distance wireless network or toward a WAN. In a short distance wireless network 116, Routing software component 550 handles broadcasting IP packets and transferring IP packets between terminals. Routing 550 is also responsible for LAN IP Broadcast emulation.

Routing software component 550 is responsible for IP packet queuing/dropping. An IP packet dropping software component is used for reducing congestion caused by having more than one terminal connected simultaneously. In an embodiment of the present invention, Routing software component 550 includes a queuing software component, Quality of Service software component or equivalent for queuing IP packets. Likewise, Routing software component 550 includes a dropping software component that is configured by manager server 102, a user or any other remote entity. In an embodiment of the present invention, manager server 102 defines and loads an IP packet queuing/dropping software component. An operator 115 will be able to define a particular queuing/dropping software component that is suitable for a particular short distance wireless network 116 or user. A user will have a better short distance wireless network 116, and thus a better user experience, without having to configure or monitor a short distance wireless network 116.

In an alternate embodiment of the present invention, Routing software component 550 is a bridge software component for transferring an IP address.

c. PPP

In an embodiment of the present invention, microrouter 404 includes a PPP software component 552, such as a PPP server that is the termination for a short distance wireless network access profile software component. A PPP server provides IP network information, such as a private IP address, DNS address or the like, to a terminal.

d. NAT

NAT software component 553 is used 1) because only one public IP address or WAN IP source address is typically made available to a cellular telephone and 2) in order to conserve public IP addresses provided by an operator. In an embodiment of the present invention, WAN 105, and in particular, a cellular packet switching network 129, provides device 106 with one public WAN IP address. A short distance wireless network 116 however includes more than one participating terminal. In order to provide IP addresses to all terminals 107, private short distance wireless network IP addresses will be used for short distance wireless network terminals while NAT 553 is responsible for translations between private short distance wireless network IP addresses and public WAN IP addresses, and vice versa.

e. GPRS Profile

GPRS profile software component 555 is responsible for obtaining IP packets in a GPRS format received by device 106 by way of cellular network 129 and providing the received IP packets to routing software component 555 for transfer to one or more terminals 107 and/or device 106. In an embodiment of the present invention, a GPRS packet is received from APN 190a. Likewise, GPRS software profile software component 555 is responsible for preparing IP packets from one or more terminals 107 and/or device 106 for transferring to APN 190a. GPRS profile software component 555 is also responsible for attaching, or obtaining a public IP address for device 106, from APN 190a in response to a control signal. Similarly, GPRS profile software component 555 is also responsible for disconnecting, or releasing a previously assigned public IP address, to APN 190a responsive to a control signal.

f. APN Attachment Software

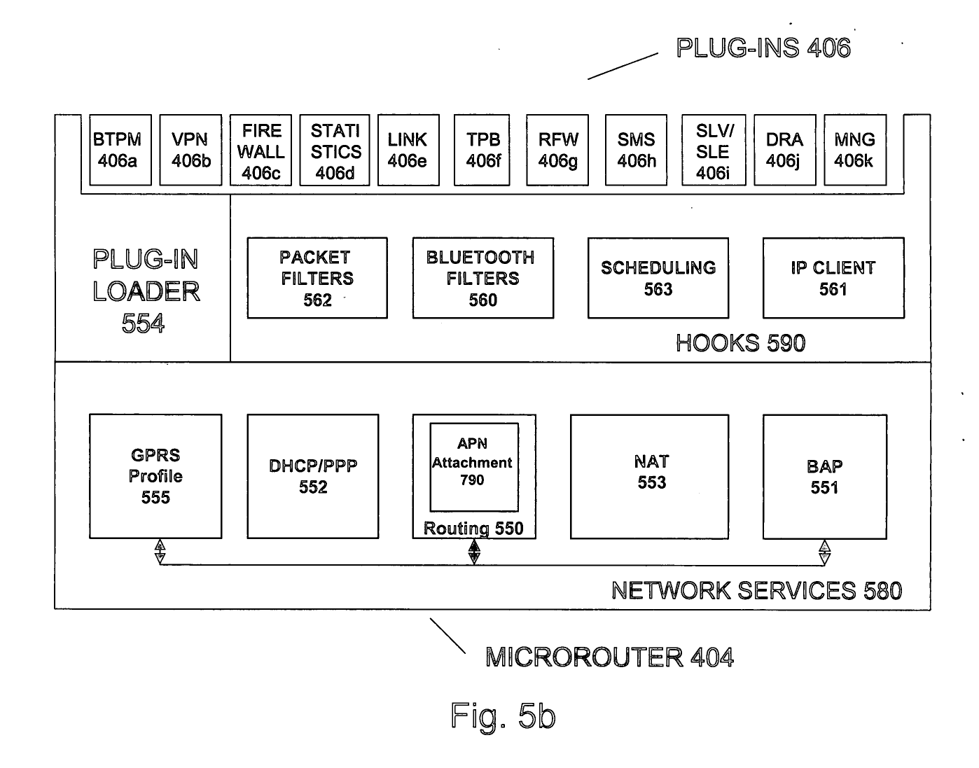

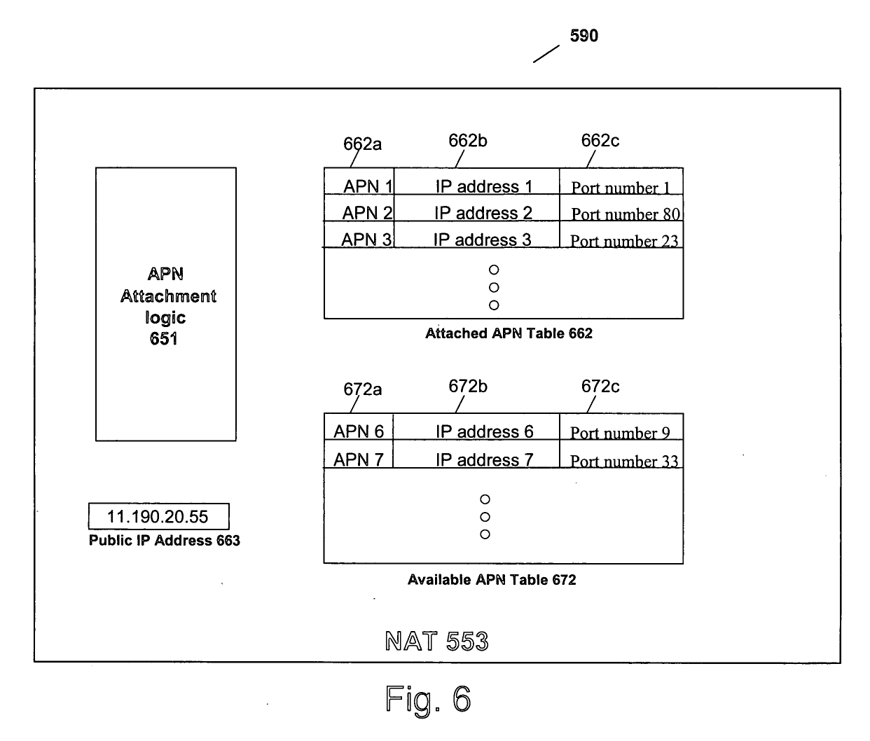

In an embodiment of the present invention, APN attachment software component 590 is included in NAT software component 553 as illustrated in FIGS. 5a and 6. In an alternate embodiment of the present invention, APN attachment software component 790 is included in Routing software component 550 as illustrated in FIG. 5b. In still another embodiment, APN attachment software component 890 is a separate software component and not included in either NAT software component 553 or Routing software component 550. As one of ordinary skill in the art would appreciate, the functions of APN attachment software component 590, 790 and 890 are included, singly or in combination, in other software components of microrouter 404 and/or software architecture 500 in alternate embodiments of the present invention.

Arrows shown in FIGS. 5a-b and 7 represent flow of data and/or control signals between software components. In alternate embodiments of the present invention, software components shown in FIGS. 5a-b and 7 communicate by reading values in memory locations or generate/receive a message that is represented by the arrows. For example, the arrow from NAT 553 to DHCP/PPP 552 represents a first attachment message generated by APN attachment software component 590 to establish a PPP connection between a selected terminal and a component in WAN 105, and in particular APN 190a. A second attachment message is generated to establish a second simultaneous PPP connection. As one of ordinary skill in the art would appreciate, more or less communication of data and/or control or arrows between software components may be used in alternate embodiments of the present invention.

APN attachment software components 590, 790 and 890 are responsible for simultaneously attaching multiple APNs or allowing for the transfer of data packets between WAN 105, specifically APNs 190a and 190b, and terminals 107 in short distance wireless network 116.

In an embodiment of the present invention, APN attachment software component 590, 790 and 890 attaches APNs 190a and 190b responsive to a short-range radio message from a terminal to a device 106 in short distance wireless network 116. For example, PDA 107b may generate a message by way of short-range radio signals 110 that includes a destination address that is an IP domain with predetermined privileges, or a particular APN.

In embodiments of the present invention, APN attachment software components 590, 790 and 890 cause a short-range LAN access profile connection or a dial-up connection with the terminal to be connected to WAN 105.

In an embodiment of the present invention, APN attachment software components 590, 790 and 890 attach a plurality of APNs simultaneously responsive to a plurality of messages from a respective plurality of terminals. As long as at least one terminal requests an APN, APN attachment software components 690, 790 and 890 will maintain a connection to the requested APN.

FIG. 5a illustrates an embodiment of the present invention in which APN attachment software component 590 is included in NAT 553. APN attachment software component 590 generates an attach control signal to GPRS Profile software component 555 responsive to a determination that a terminal is to be connected to WAN 105, and in particular a requested APN. Likewise, APN attachment software component 590 generates a detach signal to GPRS Profile software component 555 when a determination that a terminal is to be detached from an APN. APN attachment software component 590 generates an attach or detach signal responsive to a short-range radio message obtained from one or more terminals 107, by way of BAP 551.

FIG. 6 illustrates a detailed view of APN attachment software component 590 including APN attachment logic 651, memory location for public IP address 663 and tables 662 and 672. In an embodiment of the present invention, APN attachment logic 651 is responsible for making determination as to whether to generate a attach or detach control signal. For example, attachment logic 651 reads table 662 to determine whether a particular APN is currently attached or table 672 to determine whether a particular APN is available.

Table 662, stored in a plurality of memory locations, includes a list of attached APNs to terminals in short distance wireless network 116 shown in column 662a, corresponding IP addresses for the APNs seen in column 662b and corresponding port numbers seen in column 662c. For example, according to table 662, three APNs “APN 1”, “APN 2” and “APN 3” having respective IP addresses and port numbers 1, 80 and 23, respectively, are currently simultaneously attached.

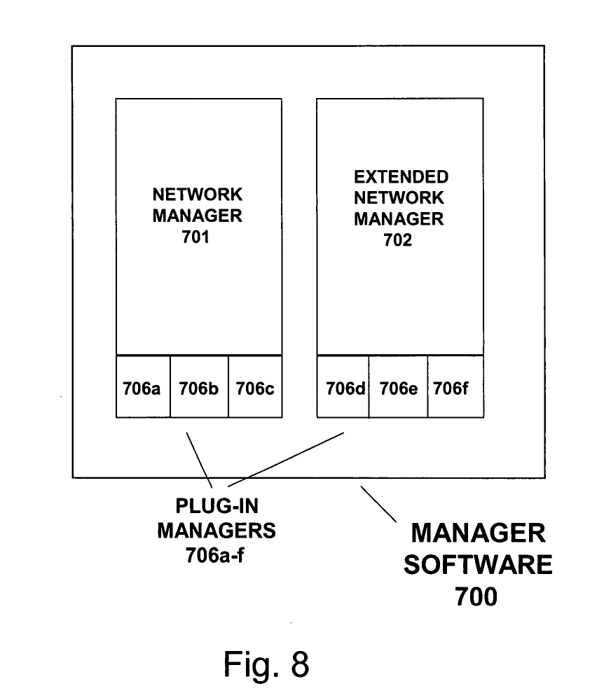

Table 672, stored in a plurality of memory locations, includes a list of available but not yet attached APNs. In particular, column 672a lists available APNs, column 672b, lists corresponding IP addresses and column 672c lists corresponding port numbers. A manufacturer or distributor in an embodiment of the present invention stores these values. In an alternate embodiment of the present invention, the available APNs are loaded from manager software 700 into table 672 shown in FIG. 8.

APN attachment logic 651 maintains an attachment to a plurality of APNs when one or more terminals request multiple APNs.

APN attachment logic 651 also includes a timing logic and access to queued data packets from and to WAN 105 in Routing 550 to determine whether to attach to a particular APN.

A public IP address assigned by a component in WAN 105, such as server 101, is obtained by device 106 and stored in memory location 663. The public IP address is then associated with one or more terminals in short distance wireless network 116 in an embodiment of the present invention.

FIG. 5b illustrates a similar embodiment of the present invention. APN attachment software component 790 is included in Routing software component 550. In this embodiment, APN attachment logic 651 is included in Routing software component 550 in order to access queued data packets from respective terminals. APN attachment logic 651 in APN attachment software component 790 also has access to a table identifying private IP addresses and/or tables 662 and 672 in NAT software component 553 in an embodiment of the present invention.

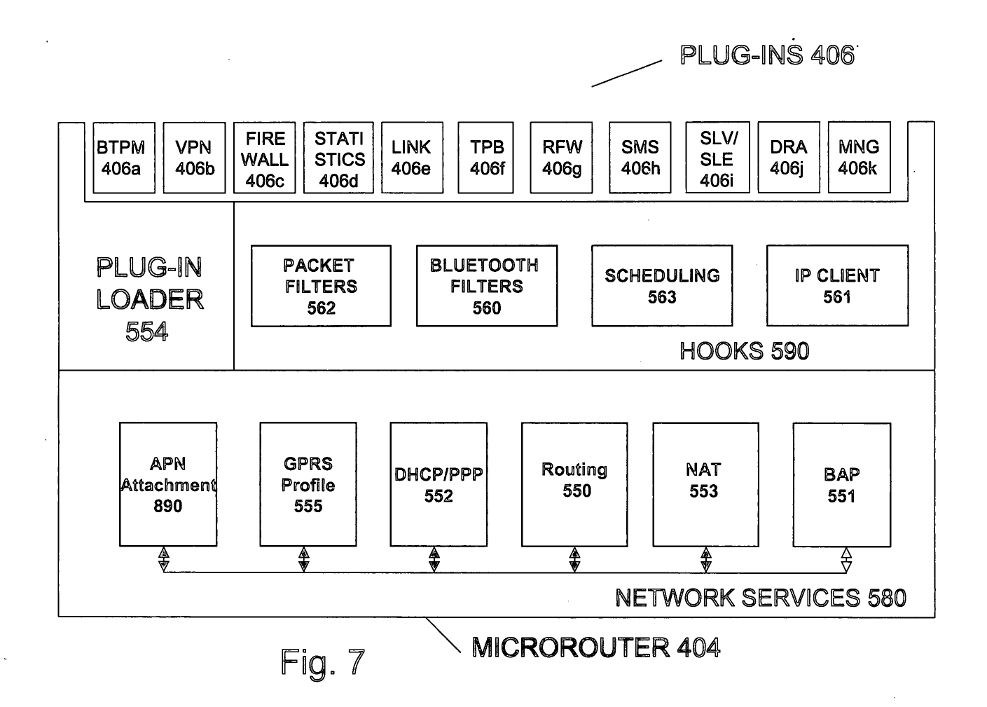

FIG. 7 illustrates another embodiment in which AP attachment software component 890 is a separate software component and transfers data and control signals to and from GPRS Profile 555, DHCP/PPP 552, Routing 550, NAT 553 and BAP 551 software components.

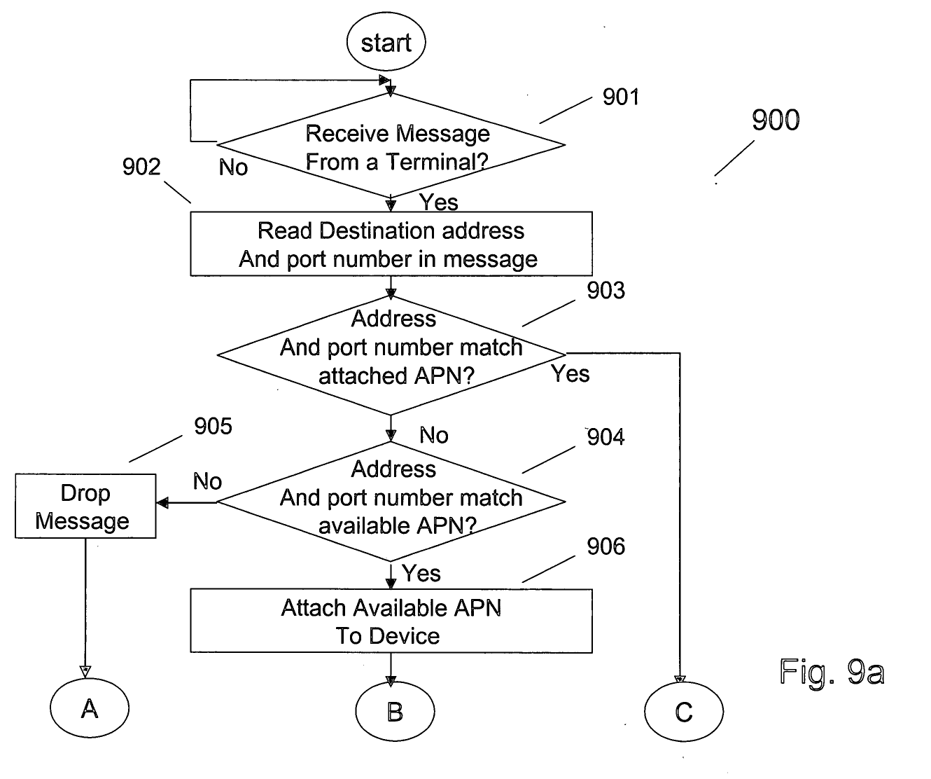

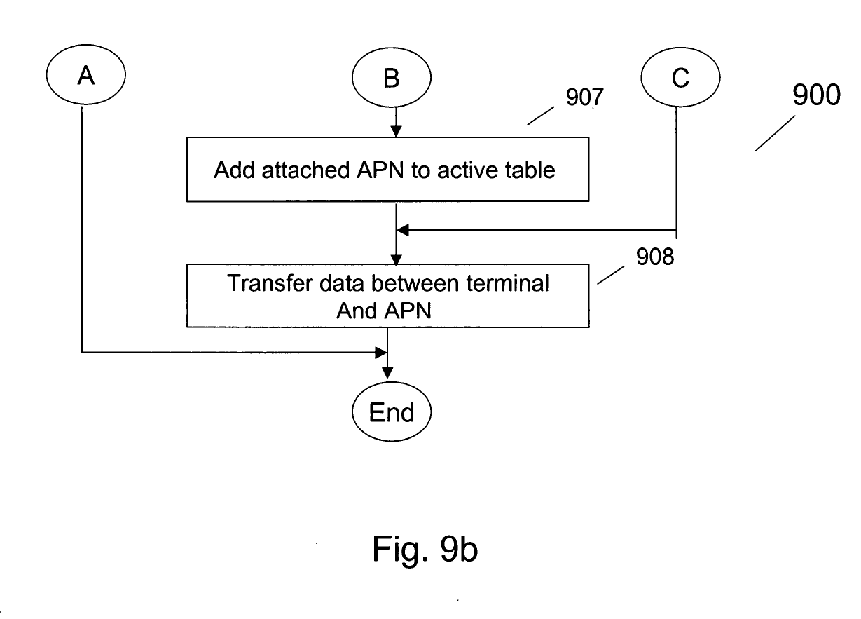

FIGS. 9a-b illustrate method 900 for simultaneously attaching a APN in WAN 105 and short distance wireless network 116 according to an embodiment of the present invention. In an embodiment, a method is performed, in part or completely, by software components illustrated in FIGS. 4-7. In an embodiment of the present invention, a logic block or step illustrated in FIGS. 9a-b may represent an execution of a software component, such as a software program, a software object, a software function, a software subroutine, a software method, a software instance, a code fragment singly or in combination. In an alternate embodiment of the present invention, logic block or step represents execution of a software component, hardware operation, or user operation, singly or in combination. In an alternate embodiment of the present invention, fewer or more logic blocks or steps are carried out in the methods illustrated in FIGS. 9a-b.

FIG. 9a illustrates method 900 for simultaneously attaching APNs 190a and 190b in WAN 105 to a terminal in short distance wireless network 116 according to an embodiment of the present invention. Method 900 begins by determining whether device 106 has received a short-range radio message from any of the terminals in a short distance wireless network 116. For example, a terminal may generate a short-range radio message to device 106. In an embodiment of the present invention, the message includes a destination address having an IP address and port number. In logic block 902, the destination address is read. A determination is made whether the destination address includes an APN that is currently attached in logic block 903. In an embodiment of the present invention, APN attachment software component 590, in particular APN attachment logic 651 compares the contents of the destination address with active APNs in table 662. If the APN is not currently attached, control passes to logic block 904. Otherwise, control passes to logic block 908 were data packets are transferred between the attached APN and requesting terminal.

In logic block 904, a determination is made whether the requested APN is available in WAN 105. In an embodiment of the present invention, APN attachment software component 590, in particular APN attachment logic 651 compares the contents of the destination address with available APNs in table 672 shown in FIG. 6. In the APN is not currently available, the message from the terminal is dropped and method 900 ends. If the APN is available and not attached, control passes to logic block 906 where the APN is attached to the requesting terminal by way of device 106.

Logic block 907 illustrates adding the recently attached APN to a list of attached APNs. In an embodiment of the present invention, APN attachment logic 651 removes an available APN from table 672 and adds it to attached APN table 662.

In an embodiment of the present invention, a terminal in short distance wireless network 116 is attached by then establishing a TCP/IP connection to server 101 by way of device 106. A TCP/IP connection is established by using a stored public IP address provided by server 101 and stored in memory location 663 as seen in FIG. 6. Thus, a plurality of IP packets are transferred between server 101 and the terminal needing access to an APN in WAN 105 as illustrated by logic block 908. In alternate embodiments of the present invention, other communication connections are established between the terminal and components of in WAN 105.

In an alternate embodiment of the present invention, an application software component in device 106 requests an APN and APN attachment software component 590, 790 or 890 allows for attaching the requested APN responsive to a request from the application software component in embodiments of the present invention. For example, watch 107a is a terminal that accesses a watch application software component on device 106. A watch application software component provides messages and/or information to watch 107a responsive to user interaction or short-range radio messages from watch 107a. A user may indirectly request an APN by a user entry at watch 107a or watch 107a requests information from the corresponding watch application software component stored on device 106 that then initiates an attachment to an APN in order to provide the requested information to watch 107a.

2. Hooks to Extended Network Service Plug-Ins

In an embodiment of the present invention, microrouter 404 includes hooks 590 allowing for the extension of microrouter 404 networking services, such as plug-ins 406. In an embodiment of the present invention, hooks 590 are application program interfaces (“API”) for plug-ins 406.

In an embodiment of the present invention, microrouter 404 is programmed to have only basic network abilities and a very low footprint, or in other words require very little memory, for example 100 K bytes, in order to be stored in a device 106, such as a cellular telephone. However, in some instances more network services will be needed. Further, operators may want the ability to add and sell network services after the device 106 is sold and in operation without user intervention. A user may be less likely to purchase a network service if the user has to return device 106 to the manufacturer or an inconvenient site.

For these and other reasons, the microrouter 404 includes hooks 590 that enable plug-ins 406 to be implemented in an embodiment of the present invention. This plug-in capability does not define a full execution environment but defines a small framework for implementing code, which can plug-in and extend microrouter 404 network services. In an embodiment of the present invention, hooks 590 are not a user application framework, plug-in code abilities are limited and serve only as an extension to network services.

Plug-ins 406 are fully activated by microrouter 404, which has full control over them in an embodiment of the present invention. In some sense, plug-ins are like a Dynamic Link Library (“DLL”) that have a predetermined set of functions that a microrouter can call in order for them to realize the needed functionality.

Below describes software components included in hooks 590 for implementing plug-ins 406 according to an embodiment of the present invention. In an alternate embodiment, other software components are included or replace illustrated software components in hooks 590. For example, software components implementing functionality used by all plug-ins 406, such as hooks for centralized configuration and backend connectivity, are included in hooks 590 in an embodiment of the present invention. These included software components in hooks 590 will save resources and allow for efficient operation.

a. Packet Filters

Packet filters software component 562 allows plug-ins 406 to process IP packets going either internally in a short distance wireless network 116 or externally to and from a WAN. By enabling plug-ins 406 to process IP packets, change any part of a packet, drop a packet or generate more packets, microrouter 404 is able to include multiple other added extended network services. For example, microrouter 404 is able to include a VPN, a firewall, tag packets, monitor packets and other extended network services described below. In an embodiment of the present invention, packet filters 562 is a data path for transferring IP packets that are accessible by plug-ins 406.

b. Bluetooth™ Filters

Bluetooth™ filters software component 560 enables plug-ins 406 to process Bluetooth™ information. In an embodiment, Bluetooth™ filters 560 processes a pairing request event and provides a PIN number. In an embodiment of the present invention, Bluetooth™ filters 560 enables added network services such as PIN management, denying access to a short distance wireless network 116 from a terminal, authenticating a terminal, pairing through an interactive voice response (“IVR”) system or the Internet. In an embodiment of the present invention, a Bluetooth™ filter 560 is a data path for transferring Bluetooth™ information that is accessible by plug-ins 406.

c. Scheduling

In order for plug-ins 406 to be able to generate events, traffic or do periodic tasks, a scheduling software component 563 enables a plug-in to receive a callback periodically or when required by the plug-in. For example, Scheduling software component 563 enables a statistics plug-in to send statistic information on terminal and application usage every X hours or calculate average traffic at a selected terminal.

d. IP Client

In an embodiment of the present invention, IP Client software component 561 makes available IP services to plug-ins 406 so a plug-in can obtain an IP address, send IP packets and/or receive IP packets. Thus, IP Client software component 561 enables a plug-in to obtain a private IP address from microrouter 404 and connect to a backend server, such as manager server 102. An IP client 561 can implement a TCP/IP stack or User Datagram Protocol (“UDP”). In an embodiment of the present invention, IP Client plug-in 561 uses all necessary microrouter 404 network services, such as packet filters 562 or NAT 553. From a microrouter 404 perspective, an IP Client 561 is treated like any other terminal on a short distance wireless network 116.

3. Plug-In Loader

A plug-in can be attached to a microrouter 404 during or after manufacturing. In an embodiment of the present invention, a plug-in is stored or programmed in device 106 before shipping from a manufacturer. Alternately, a plug-in is downloaded from manager server 102 at run-time over WAN 105.

A Plug-In Loader software component 554, as illustrated in FIG. 5, is responsible for loading plug-ins 406, programming of plug-ins 406 and notification of newly available plug-ins 406 to microrouter 404 in an embodiment of the present invention.

In an embodiment of the present invention, Plug-In Loader 554 will use operating system 403 capabilities for programming a file system and access of plug-ins 406. In an alternate embodiment of the present invention, Plug-In Loader 554 uses a plug-in directory in a dedicated memory space of device 106.

4. Microrouter Extended Service Plug-Ins

Below describes microrouter 404 extended service plug-ins 406 in an embodiment of the present invention. In various embodiments of the present invention, one or more of plug-ins 406 are attached to microrouter 404. In alternate embodiments, other plug-ins are attached to microrouter 404. In an embodiment of the present invention, a device manufacturer, terminal manufacturer, an operator 115 and/or other third party provides a plug-in.

a. Bluetooth™ Terminal Pairing Management (“BTPM”)

BTPM software component plug-in 406a is responsible for PIN management and authenticating terminals for participating in a short distance wireless network 116. BTPM 406a allows an operator 115 to control which terminal can connect to a short distance wireless network 116. For example, an operator 115 can deny a terminal from pairing to a short distance wireless network 116, or can approve a terminal for pairing. In an embodiment of the present invention, pairing is done over an IVR, the Internet and/or by a user.

b. VPN

VPN software component plug-in 406b enables a secure link to a network, such as a private corporate network. VPN enables terminals to connect to a corporate file server, exchange server or an equivalent. VPN 406b uses packet filters 562 in order to identify packets that are routed to a corporate LAN IP subnet. In an embodiment of the present invention, VPN 406b then encrypts and tunnels the identified IP packets.

c. Firewall

Firewall software component plug-in 406c protects a short distance wireless network 116 from intruders and hackers. In an embodiment of the present invention, Firewall 406c uses packet filters 562 for identifying IP packets from non-authorized sources and IP packets that are sent to non-authorized servers. In an embodiment of the present invention, firewall 406c enables Uniform Resource Locator (“URL”) filtering.

d. Statistics

In an embodiment of the present invention, Statistics software component plug-in 406d collects usage profiles and statistics on 1) which terminal in a short distance wireless network 116 is used, 2) how much traffic is generated by each terminal, and 3) how much traffic is generated by each application. Statistics 406d enables an operator 115 to promote used terminals and build billing schemes.

e. Link Optimizations

Implementing direct TCP/IP and Internet application protocols over WAN 105, and in particular a wireless network, produces poor performance because of low bandwidth, transmission delays and high data error rates. In order to solve the poor performance but still enable terminals to use standard TCP/IP, a Link Optimization software component plug-in 406e is provided. Link Optimization 406e traps all TCP/IP and specific Internet application protocols, such as Simple Mail Transfer Protocol (“SMTP”) and Hypertext Transfer Protocol (“HTTP”), and converts the protocol to an optimized protocol. Link Optimization 406e then sends the converted packets to a backend server, such as manager server 102, which then deconverts the packets and sends them onto the Internet. In an embodiment of the present invention, terminals and users are not aware of using Link Optimization 406e.

f. Reverse Firewall

As opposed to a typical LAN firewall that protects a short distance wireless network 116 from intruders and hackers from the Internet or another network, a Reverse Firewall (“RFW”) software component plug-in 406g protects an operator 115 or another network from terminals and applications on a short distance wireless network 116 generating traffic toward those networks. RFW 406g enables an operator 115 or another entity to define and enforce usage policies for applications/terminals on a short distance wireless network 116. RFW 406g prevents unnecessary costly transmission costs. Enforcement of usage policies at the short distance wireless network level (i.e. at device 106) prevents expensive packets from going through a cellular network that will be eventually dropped. Further, packets that may be later dropped do not use the limited cellular transmission bandwidth.

In an embodiment of the present invention, RFW 406g is attached to a cellular handset that has Bluetooth™ capability for implementing a short distance wireless network 116 and GSM/GPRS for cellular access to a WAN 105 (i.e. Internet or any other network). RFW 406g is programmed to drop packets based on the originating terminal, originating application/terminal pair or original application. For example, if a user has a PDA and a Notebook, an operator 115 can configure for File Transfer Protocol (“FTP”) packets from the PDA to be dropped if FTP from a PDA is not allowed, or for example to drop video streaming packets originated from the Notebook if video streaming is something the operator 115 does not allow.

Another example includes blocking Notebook usage of such software as Napster in order to avoid cellular unintended usage by users and associated cost.

g. Terminal Programming over Bluetooth™ (“TPB”)

TPB software component plug-in 406f enables the programming of terminals 107 over Bluetooth™ and over a cellular network. In an embodiment of the present invention, programming a terminal is accomplished by “flashing” or programming EEPROM memory in a terminal. An operator 115 or manufacturer can transfer a flash image to be flashed to device 106 having microrouter 404, and terminals 107 to be flashed. TPB 406f communicates with a Flashing software component in a terminal to 1) initiate the flashing process, 2) authenticate the flash image and 3) secure the flashing process.

In an embodiment of the present invention, flashing is done by transferring a full flash image. Alternatively, if there is not enough memory for the full flash image in device 106, the flash image is transferred block by block to eventually be flashed.

TPB 406f enables customizing a terminal, fixing software running on a terminal, and adding applications and/or improvements.

h. Short Message System (“SMS”) Plug-In

SMS software component plug-in 406h allows terminals 107 to send messages between each other in a short distance wireless network 116. In an embodiment of the present invention, a terminal is a Messaging Terminal that enables Instant Messaging over IP. In an alternate embodiment of the present invention, SMS 406h enables standard legacy SMS or Instant Messaging over SMS.

In an embodiment of the present invention, SMS 406h is an SMS server for terminals 107 and an SMS termination for device 106. In this way, a protocol will be defined that enables each terminal to send a packet to SMS 406h with a destination device phone number+message text. SMS 406h then sends the SMS message to a cellular network.

SMS 406h also serves as an SMS receiver in an embodiment of the present invention. A terminal can inquire SMS 406h for received SMS messages and fetch those messages. In still another embodiment of the present invention, a terminal will also receive an IP broadcast message each time an SMS message is received by device 106.

i. Service Level Verification (“SLV”)/Enforcement (“SLE”)

SLV/SLE software component plug-in 406i enables an operator 115 to verify and enforce service level agreements with users. If an operator 115 wants to enforce service levels, such as specifically limiting the amount of traffic over a cellular network, SLV/SLE 406i is added in order to avoid usage of expensive airtime.

In an embodiment of the present invention, SLV/SLE 406i allows a user to generate an unlimited amount of cellular traffic from device 106 during the night but a limited amount during the day. So during the day, if the limited amount is exceeded no more traffic can be generated from device 106 and packets are dropped by SLV/SLE 406i. Similar policies may likewise be enforced. SLV/SLE 406i also identifies and notifies operator 115 of missed cellular network usage by a particular user due to enforcement in an embodiment of the present invention.

j. Device Resources Access (“DRA”)

DRA software component plug-in 406j enables terminals to gain access (according to defined restrictions) to device 106 resources. This enables a terminal to implement a Device Resources Access protocol over IP in order to gain access to any of the following resources: 1) phone book, 2) play a ring tone, 3) initiate a call, 4) user interface, or 5) other device resources.

DRA 406j enables a terminal to read/modify/add phone book entries in a phone book stored on device 106. In a preferred embodiment, a vCard format is used to exchange entry information between device 106 and terminals 107. This enables a better consistent experience for users. For example, DRA 406j provides a user immediate access to a device 106 phone book entries for sending a message from a messaging terminal without having to type the contact information from the phone book.

DRA 406j enables a user to be alerted by using a device 106 ring buzzer. Thus, a terminal in short distance wireless network 116 can use a device 106 ring buzzer for alerting a user.

DRA 406j enables a terminal, such as a PDA or an Outlook application on a notebook computer, to initiate a telephone call at device 106. In an embodiment of the present invention, clicking a phone icon near a phone number on a notebook display initiates a cellular telephone call.

Likewise, DRA 406j enables a terminal to interact with a user through device 106 menus and input components.

k. Terminal Management/Monitoring (“MNG”)

MNG software component plug-in 406k enables management, configuration and monitoring of terminals 107 in an embodiment of the present invention. Instead of each terminal implementing a proprietary management protocol and console, each terminal exposes a “registry” of parameters and MNG 406k implements a protocol enabling a managing server 102 to browse this registry, get values and set values.

IV. Usage Scenarios

A. PDA Synchronizes Against the Corporate Exchange Server

In this scenario, a user is a traveling professional who has a PDA and needs to synchronize it against a corporate exchange server while on the road. This synchronization needs to be done securely as the only way to enter the corporate network is via a certified and Information Technology (“IT”) manager approved VPN.

The user also has a cellular telephone having a microrouter 404 and VPN client 406j, which the IT manager installed. The IT manager used the remote management capabilities of the cellular telephone in order to configure a VPN to connect to the corporate network, as well as configured the firewall to block Internet access while the VPN is in use. The user is totally unaware of the VPN and its configurations.

As the user turns on the PDA, which is a Bluetooth™ equipped PDA with a LAN Access profile implementation, the PDA connects to the cellular telephone via the BAP 551 utilizing Bluetooth™. The PDA receives a private IP address.

The user loads the PDA synchronization software, which is configured to synchronize against the corporate exchange server. When hitting the “Synchronize” button, the PDA opens a TCP connection to the IP address of the corporate network.

The IP packets travel across the Bluetooth™ air interface to the cellular telephone using a PPP protocol and PPP 552. When reaching the cellular telephone, the packets go through NAT 553 and the private IP address is translated to a public IP address. The public IP address goes to VPN 406f, which identifies the destination as the corporate LAN. VPN 406f packages the packet over an Internet tunnel, encrypts and signs it. The packet is then sent through the cellular air interface and the Internet, reaching the corporate VPN and exchange servers. The PDA is totally unaware of this process.

B. PDA Synchronizes against a Notebook on the Short Distance Wireless Network

In this scenario, the user, as described above, needs to synchronize the PDA with a notebook computer.

The notebook has a Bluetooth™ card with a LAN access profile. Once the notebook is turned on, it connects to the user's cellular telephone having microrouter 404 and receives a private IP address.

The user runs the same synchronization software on his PDA, only this time chooses to synchronize with the notebook.

When hitting the “Synchronize” button on the PDA, the PDA opens a TCP connection to the notebook's IP address.

An IP packet travels, from the PDA, through the Bluetooth™ interface over a PPP protocol and reaches routing 550 in microrouter 404 that identifies the packet destined to a private IP address of the notebook. The IP packet is then sent to the notebook through the notebook's Bluetooth™ interface over a PPP protocol.

C. Web Pad Browsing the Internet

In this scenario, a user has a Web Pad equipped with a Bluetooth™ interface with a LAN access profile. The Web Pad is connected to the cellular telephone having microrouter 404, which is in the user's bag, and receives a private IP address through the LAN access profile. The Web Pad also has a web browser.

The user pulls out his Web Pad, goes to a URL line of the browser and types http://www.iximobile.com. The web browser first has to translate the name www.iximobile.com into a public IP address. This is done using a Domain Naming Service (“DNS”) protocol. The Web Pad already received the private IP address of a DNS plug-in when it connected to the cellular telephone. The Web Pad sends a resolve request to the DNS plug-in software component in microrouter 404. DNS software component looks at its cache for the name. If the name is not available, the DNS plug-in software component goes to the next DNS on a WAN 105 to get the public IP address of the name. In both cases, the DNS eventually gets the public IP address for www.iximobile.com and sends the reply back to the Web Pad. In an embodiment of the present invention, a DNS software component is a plug-in 406 or a hook 590.

When the Web Pad receives the public IP address of the web site, it opens a TCP connection at port 80 of that public IP address in order to implement the HTTP protocol and get the HTML page to display.

V. Manager Server

In an embodiment of the present invention, Manager server 107, illustrated in FIG. 1, includes Manager software component 700 illustrated in FIG. 8. In an embodiment of the present invention, Manager software component 700 is used to load microrouter 404 and plug-ins 406 into device 106. In an additional embodiment of the present invention, Manager software 700 is used to manage, configure and collect data from short distance wireless network 116. In still another embodiment of the present invention, manager software 700 is not used with short distance wireless network 116.

Manager server 102 includes a Proliant server available from Compaq® Computer Corporation of Houston, Tex. having a Windows® 2000 operating system available from Microsoft® Corporation in an embodiment of the present invention.

In an embodiment of the present invention, Manager software component 700 has an IP interface in order to gain access to microrouter 404 and access a device notification service, such as SMS 406h. Manager 700 can be installed on any network that has IP connectivity to microrouter 404. Manager 700 can be installed by a service provider on Internet 103, or by an operator 115 on its IP backend network having server 102.

Manager software component 700 includes two software components, Network Manager software 701 and Extended Network Manager software 702, in an embodiment of the present invention.

Network Manager software 701 is responsible for, but not limited to, the following functions: 1) configuring an IP parameter, such as IP domain range or policies, 2) configuring plug-ins 406 currently installed and executed, 3) enabling/disabling an installed plug-ins 406, 4) loading new plug-ins in microrouter 404, and 5) removing plug-ins 406 from microrouter 404.

Network Extended Manager software 702 is responsible for, but not limited to, the following functions: 1) collecting usage profiles for each microrouter 404 and each terminal in short distance wireless network 116, 2) managing PINs, such as denying access to short distance wireless network 116 for a particular terminal or approving access to short distance wireless network 116 for other terminals, 3) managing security, such as configuring VPN 406b or configuring Firewall 406c, 4) configuring Link Optimization 406e, and 5) configuring Quality of Service (“QoS”) parameters in microrouter 404.

In an embodiment of the present invention, Plug-In Manager software components 706a-f are stored in manager server 102 and use network manager software component 701 and/or Extended Network Manager software component 702 for accessing and controlling network plug-ins 406a-k. For example, a Plug-In Manager software component 706d is used to obtain statistics information from Statistics plug-in 406d in microrouter 404. In an embodiment of the present invention, there is a corresponding plug-in Manager software component in manager software 700 for every plug-in software component in microrouter 404.

VI. Conclusion

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1) A wireless handheld device, comprising:
a processor; and,
a memory, coupled to the processor, capable to store a software component for simultaneously attaching a short distance wireless network to a wide area network having a first address providing a first service and a second address providing a second service.

2) The device of claim 1, wherein the first and second addresses identify a domain providing respective predetermined privileges.

3) The device of claim 1, wherein the first and second addresses are access point names (“APNs”).

4) The device of claim 1, wherein the first and second addresses include a first and second port number.

5) The device of claim 1, wherein the first service provides a wireless application protocol (“WAP”)

6) The device of claim 1, wherein the first service provides access to the Internet.

7) The device of claim 1, wherein the first service provides a hypertext transfer (“HTTP”) protocol.

8) The device of claim 1, wherein the first service is a multimedia messaging Service Center (“MMSC”).

9) The device of claim 1, wherein the selectively attaching includes establishing a dial-up network session.

10) The device of claim 1, wherein the selectively attaching includes establishing a short-range LAN access profile session.

11) The device of claim 1, wherein the software component selectively attaches response to a first terminal in the short distance wireless network communicating with the device.

12) The device of claim 11, wherein the communicating includes the terminal transmitting an IP message including a port number.

13) The device of claim 1, wherein the wide area network is a Global System for Mobile communications (“GSM”) cellular network.

14) The device of claim 1, wherein the short distance wireless network is a Bluetooth™ wireless local area network.

15) The device of claim 1, wherein the device further includes a short-range LAN Access profile software component.

16) The device of claim 3, wherein the software component further includes a table of available APNs.

17) A method for communicating with a cellular network, comprising the steps of:
generating a first short-range radio message including a first IP address and a first port number for the cellular network, by a terminal, in a short distance wireless network;
receiving, by a device, the first short-range radio message;
determining whether the device is attached to the first port number;
generating a cellular signal, by the device, requesting a first service from the cellular network responsive to the first short-range radio message;
generating a second short-range radio message including a second IP address and a second port number for the cellular network, by a terminal, in a short distance wireless network;
receiving, by a device, the second short-range radio message;
determining whether the device is attached to the second port number; and,
generating a cellular signal, by the device, requesting a second service from the cellular network responsive to the second short-range radio message.

18) The method of claim 17, wherein the terminal is a messaging terminal and the device is a cellular telephone.

19) The method of claim 14, wherein the cellular network is a Global System for Mobile communications (“GSM”) cellular network and the first service is a WAP service and the second service is Internet access.

20) The method of claim 14, wherein the short distance wireless network is a Bluetooth™ wireless local area network.

21) The method of claim 14, wherein the short distance wireless network is an 802.11 wireless local area network.

22) A method for communicating with a cellular network, comprising the steps of:
receiving, by a device, a plurality of short-range radio messages, from a respective plurality of terminals, in a short distance wireless network for a plurality of respective services in the cellular network; and,
attaching simultaneously to the respective services, by the device, responsive to the plurality of requests.

23) An system for providing communication between a cellular network and a short distance wireless network, comprising:
a hand-held wireless device, including:
a cellular transceiver to communicate with the cellular network;
a short-range transceiver to communicate with the short-range radio network, including to receive a first short-range radio message having a first APN and a second short-range radio message having a second APN;
a memory, coupled to the cellular and short-range radio transceivers, to store a software component to simultaneously transfer a plurality of packets to the first APN and the second APN responsive to the first and second short-range radio messages; and,
a first wireless device to generate the first and second short-range radio messages.

24) The system of claim 23, wherein the first wireless device is selected from a group consisting of a desktop computer, a laptop computer, a personal digital assistant, a headset, a pager, a pen, a printer, a watch, a digital camera and an equivalent.

25) An article of manufacture, including a computer readable medium, comprising:
a short-range radio software component to provide a short-range radio signal in a short distance wireless network;
a cellular software component to provide a communication signal in a cellular network; and,
a software component to simultaneously transfer a plurality of packets between the a first APN and a second APN in the cellular network and the short distance wireless network responsive to a first short-range radio message including a first IP address and fir port number and a second short-range radio message including a second IP address and a second port number.
